(19) United States
(12) Patent Application Publication
(10) Pub. No.: US 2021/0336358 A1
(43) Pub. Date: Oct. 28, 2021

(54) TERMINAL-FORMED ELECTRICAL WIRE AND METHOD OF MANUFACTURING TERMINAL-FORMED ELECTRICAL WIRE

(71) Applicant: Yazaki Corporation, Tokyo (JP)

(72) Inventor: Hiroshi FUJITA, Shizuoka (JP)

(73) Assignee: Yazaki Corporation, Tokyo (JP)

(21) Appl. No.: 17/234,171

(22) Filed: Apr. 19, 2021

(30) Foreign Application Priority Data
Apr. 22, 2020 (JP) 2020-076046

(51) Int. Cl. H01R 4/18; H01R 43/048; H01B 13/00; H01B 7/20

(52) U.S. Cl. CPC H01R 4/182; H01B 7/20; H01B 13/0016; H01R 43/048

(57) ABSTRACT

A terminal-formed electrical wire includes a core wire, a sheath that exteriorly covers a sheath target portion, a portion other than a core wire exposed portion, of the core wire, a metallic tubular member that accommodates the core wire exposed portion inside and is integrated with the core wire exposed portion to form a terminal unit. The core wire exposed portion has a flat board portion in the shape of a flat board thinner than the sheath target portion. The tubular member has a first wall and a second wall in the shape of a flat board sandwiching the flat board portion from respective flat surfaces of the flat board portion.

### CROSS-REFERENCE TO RELATED APPLICATION(S)

The present application claims priority to and incorporates by reference the entire contents of Japanese Patent Application No. 2020-076046 filed in Japan on Apr. 22, 2020.

### BACKGROUND OF THE INVENTION

### 1. Field of the Invention

The present invention relates to a terminal-formed electrical wire and a method of manufacturing a terminal-formed electrical wire.

### 2. Description of the Related Art

There are known conventional techniques relating to an electrical wire, particularly, what is called a terminal-formed electrical wire. These techniques shape a part of a core wire into a desired terminal shape instead of mounting a terminal hardware on the core wire. With the techniques, a core wire exposed portion is deformed into a terminal shape suitable for screw fastening, by, for example, welding wires of the core wire exposed portion, which is arranged at an end of the electrical wire, into a desired shape and solidifying the wires, and forming a through-hole for receiving a male screw in the solidified area. This type of terminal-formed electrical wire and a method of manufacturing a terminal-formed electrical wire are described in, for example, Japanese Patent Application Laid-open No. 2016-177956.

Such a conventional terminal-formed electrical wire has a plurality of wires directly pressed and heated, which problematically causes variations in the shape of a terminal unit after solidification. The quality of the terminal unit therefore needs to be further improved.

### SUMMARY OF THE INVENTION

From the above point of view, it is an object of the present invention to provide a terminal-formed electrical wire provided with a high-quality terminal unit and a method of manufacturing such a terminal-formed electrical wire.

To achieve the above objection, a terminal-formed electrical wire according to one aspect of the present invention includes a core wire; a sheath that exteriorly covers a sheath target portion, as a portion other than a core wire exposed portion, of the core wire; and a metallic tubular member that accommodates the core wire exposed portion inside and is integrated with the core wire exposed portion to form a terminal unit, wherein the core wire exposed portion has a flat board portion formed in a shape of flat board that is thinner than the sheath target portion, the tubular member has a first wall and a second wall each formed in a shape of flat board and sandwiching the flat board portion from respective flat surfaces of the flat board portion, and the terminal unit has a through-hole having a direction of a hole axis arranged along a direction perpendicular to respective flat surfaces of the first wall, the flat board portion, and the second wall.

According to another aspect of the present invention, in the terminal-formed electrical wire, it is preferable that the tubular member further accommodates a portion of the sheath connected with the core wire exposed portion.

According to still another aspect of the present invention, in the terminal-formed electrical wire, it is preferable that the core wire is a bundle of a plurality of wires.

To achieve the above objection, a method of manufacturing a terminal-formed electrical wire according to still another aspect of the present invention includes preparing by inserting a core wire exposed portion of a core wire of an electrical wire into a metallic tubular member; forming a terminal unit by making a terminal target portion of the tubular member and the core wire exposed portion inside the terminal target portion into a terminal unit having a desired terminal shape, by pressing the terminal target portion with a pair of press tools; and forming a through-hole in the terminal unit.

According to still another aspect of the present invention, in the method of manufacturing a terminal-formed electrical wire, it is preferable that at the forming the terminal unit, the terminal target portion and a plurality of wires arranged inside the terminal target portion are formed into the terminal unit, by pressing the terminal target portion with the pair of press tools while heating the terminal target portion to weld and solidify the wires inside the terminal target portion and composing the core wire exposed portion.

According to still another aspect of the present invention, in the method of manufacturing a terminal-formed electrical wire, it is preferable that at the forming the terminal unit, heat is applied to the terminal target portion by passing current to a pair of electrodes, as the pair of press tools, while the pair of electrodes is pressing the terminal target portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a terminal-formed electrical wire according to an embodiment;

FIG. 2 is a plan view of the terminal-formed electrical wire according to the embodiment when viewed in the direction of a hole axis of a through-hole;

FIG. 3 is a plan view of the terminal-formed electrical wire according to the embodiment when viewed from a side;

FIG. 4 is a drawing to explain a preparation process in a method of manufacturing a terminal-formed electrical wire according to the embodiment;

FIG. 5 is a drawing to explain a terminal unit forming process in the method of manufacturing a terminal-formed electrical wire according to the embodiment, and illustrates the cable in a state before pressing;

FIG. 6 is a drawing to explain the terminal unit forming process in the method of manufacturing a terminal-formed electrical wire according to the embodiment, and illustrates the cable in a state after pressing;

FIG. 7 is a drawing of the terminal unit when the terminal unit forming process is completed; and

FIG. 8 is a flowchart that illustrates main points of the method of manufacturing a terminal-formed electrical wire according to the embodiment.

### DETAILED DESCRIPTION OF THE PREFERRED EMBODIMENTS

A terminal-formed electrical wire and a method of manufacturing a terminal-formed electrical wire according to the present invention will now be described in detail with reference to the drawings. It should be noted that the embodiment is not intended to limit the present invention.

### Embodiment

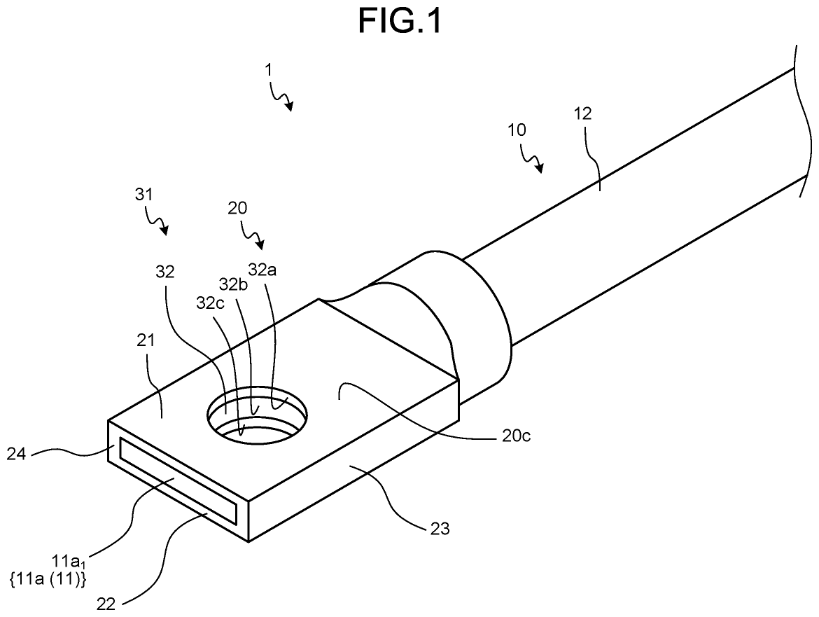

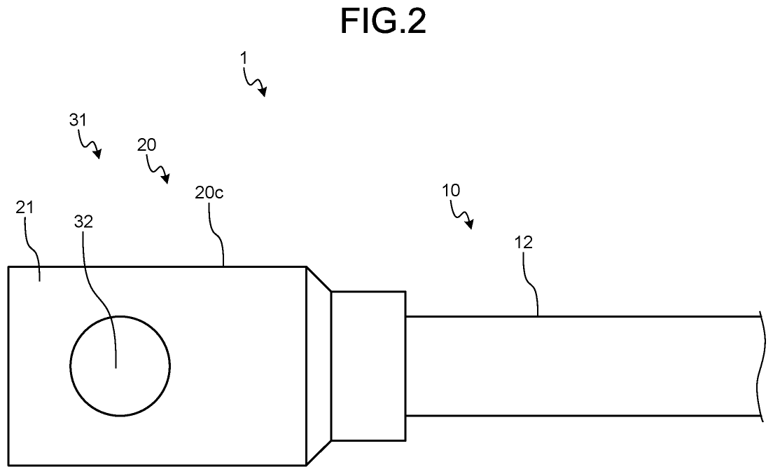

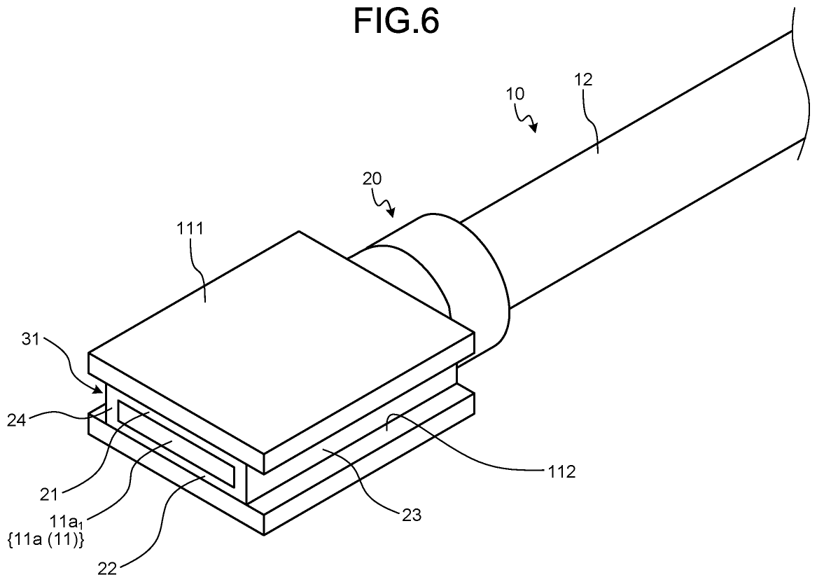

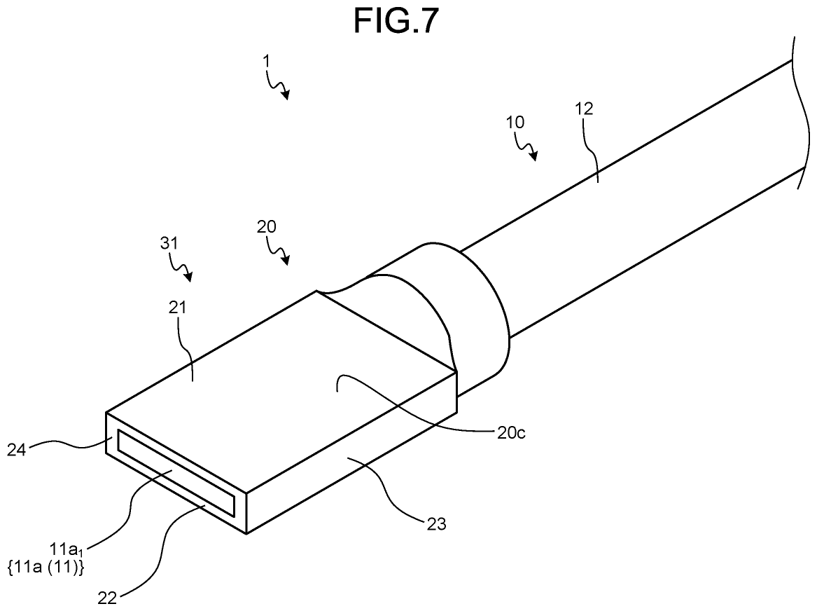

An embodiment of a terminal-formed electrical wire and a method of manufacturing a terminal-formed electrical wire according to the present invention will now be described with reference to FIG. 1 through FIG. 8.

A terminal-formed electrical wire 1 of the present invention will now be described.

The terminal-formed electrical wire 1 includes an electrical wire 10 and a metallic tubular member 20 (FIG. 1 to FIG. 3). In the terminal-formed electrical wire 1, the electrical wire 10 and the tubular member 20 are integrated to form a terminal unit by a later-described method of manufacturing.

The electrical wire 10 includes a conductive core wire 11 and an insulating sheath 12 that covers the core wire 11 (FIGS. 1, 4, and 5).

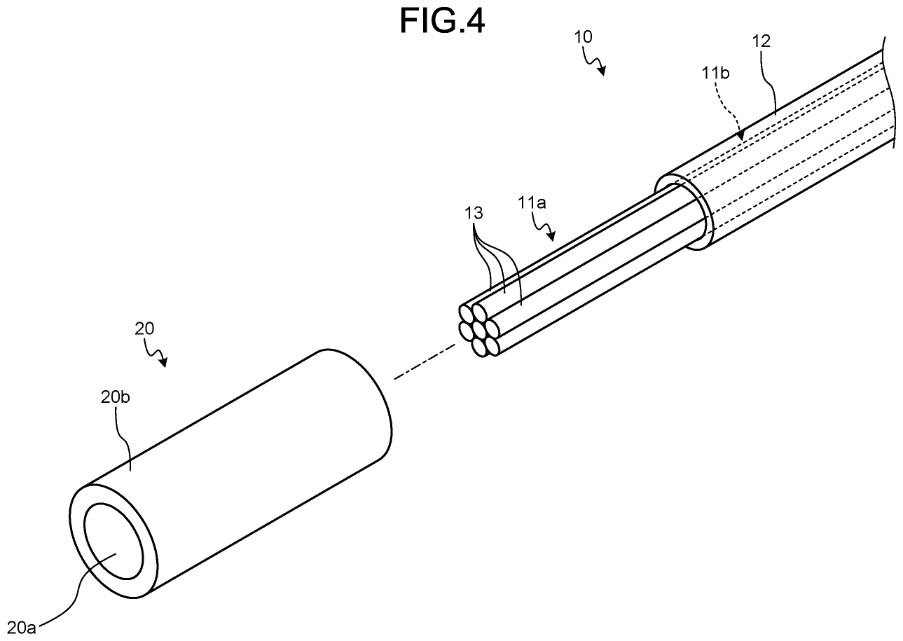

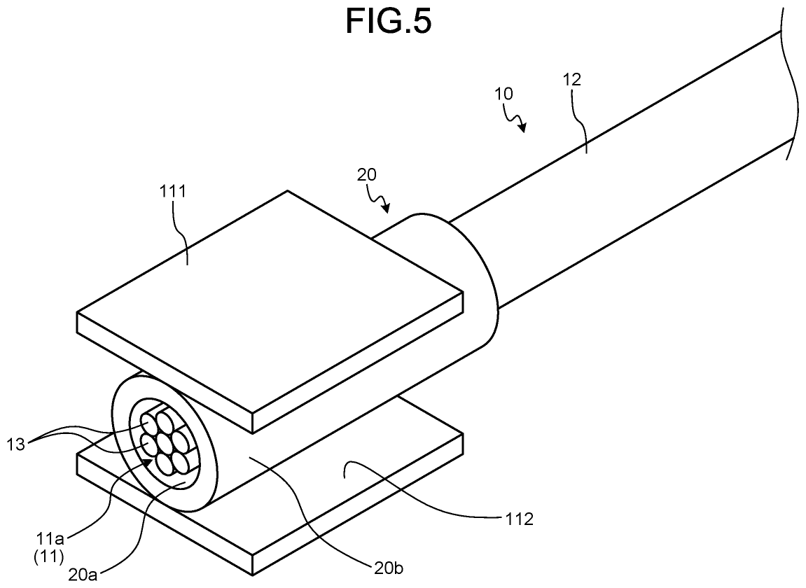

The core wire 11 may be a single wire consisting of a single rod-shaped conductor or a bundle of wires 13 consisting of a plurality of rod-shaped conductors. In any pattern of the core wire 11, the rod-shaped conductor is made of aluminum or aluminum alloy. The core wire 11 may be a bundle of wires 13 simply gathered or may be a strand in which a plurality of wires 13 are twisted together. The core wire 11 of this embodiment consists of a plurality of columnar wires 13 gathered in a shape similar to a column (FIG. 4 and FIG. 5).

The electrical wire 10 has a core wire exposed portion 11a having the core wire 11 exposed (FIGS. 1, 4, and 5). In other words, the sheath 12 exteriorly covers a sheath target portion 11b, a portion other than the core wire exposed portion 11a, of the core wire 11. The electrical wire 10 of the embodiment has the core wire exposed portion 11a at an end thereof.

The core wire exposed portion 11a has a flat board portion 11a₁ formed in the shape of a flat board. This flat board portion 11a₁ is formed by being pressed to have a thickness smaller than its initial diameter (that is, the diameter of the sheath target portion 11b), at a later-described terminal unit forming process in a method of manufacturing (FIGS. 1, 6, and 7). The core wire exposed portion 11a of the terminal-formed electrical wire 1 therefore has the flat board portion 11a₁ formed in the shape of a flat board that is thinner than the sheath target portion 11b. The terminal unit forming process allows the core wire exposed portion 11a of the terminal-formed electrical wire 1 in this embodiment to have the flat board portion 11a₁ in which the wires 13 are welded and solidified to be in the shape of a flat board thinner than a bundle of wires 13 at the sheath target portion 11b.

The tubular member 20 is made by processing a metallic material into a tube. The tubular member 20 has openings at the respective ends thereof in the direction of the tube axis. For example, the tubular member 20 of this embodiment is made of copper. The tubular member 20 accommodates therein the core wire exposed portion 11a. The tubular member 20 of this embodiment is cylindrical, and is configured such that the core wire exposed portion 11a is inserted into the tubular member 20 from its leading end through an opening at one of the ends, at a later-described preparation process in the method of manufacturing (FIG. 4). For example, the core wire exposed portion 11a is inserted into the tubular member 20 and moved until the leading end reaches another opening 20a of the tubular member 20.

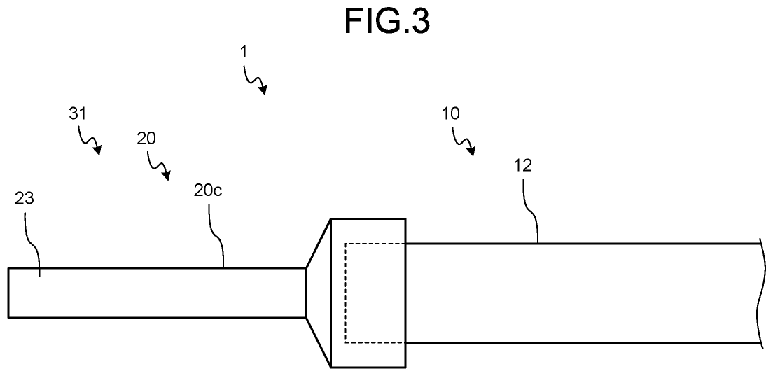

The tubular member 20 may accommodate therein only the core wire exposed portion 11a or may accommodate the core wire exposed portion 11a and a portion of the sheath 12 connected with the core wire exposed portion 11a. The tubular member 20 of this embodiment accommodates the core wire exposed portion 11a together with the end of the sheath 12 closer to the core wire exposed portion 11a. This means that a portion of the sheath 12 connected with the core wire exposed portion 11a is accommodated in the tubular member 20 (FIG. 3). The terminal-formed electrical wire 1 configured as above can keep water from entering the cable from the side with the sheath 12 toward the core wire exposed portion 11a and thus can protect the core wire exposed portion 11a from corrosion.

This tubular member 20 is integrated with the core wire exposed portion 11a located inside to form a terminal unit 31 of the terminal-formed electrical wire 1 (FIG. 1). The entire tubular member 20 may be flattened to form the terminal unit 31 with the core wire exposed portion 11a located inside, or may have a part of the tubular member 20, which is a terminal target portion 20b, flattened to form the terminal unit 31 with the core wire exposed portion 11a inside the terminal target portion 20b. In the tubular member 20 of this embodiment, the terminal target portion 20b is flattened together with the core wire exposed portion 11a inside the terminal target portion 20b to form the terminal unit 31 (FIG. 1 and FIGS. 5 to 7).

At the later-described terminal unit forming process in the method of manufacturing, the terminal target portion 20b is flattened to be a rectangular tubular compressed tube portion 20c or to be the compressed tube portion 20c having an oval cross-section with respect to the tube axis direction (FIGS. 1, 6, and 7). On the compressed tube portion 20c, the tubular member 20 has a first wall 21 and a second wall 22 each shaped in rectangular flat boards and sandwiching the flat board portion 11a₁ of the core wire exposed portion 11a therebetween from the respective flat surfaces of the flat board portion Hai. On the compressed tube portion 20c, the tubular member 20 further has a third wall 23 that connects ends of the first wall 21 and the second wall 22 and a fourth wall 24 that connects the other ends of the first wall 21 and the second wall 22. The third wall 23 and the fourth wall 24 hold the flat board portion 11a₁ therebetween.

In the terminal-formed electrical wire 1, the terminal unit 31 is formed from the flat board portion 11a₁ of the core wire exposed portion 11a and the compressed tube portion 20c of the tubular member 20, in the shape of a flat board having a rectangular or oval cross-section in the direction of the tube axis of the tubular member 20. The terminal unit 31 has a through-hole 32 having the direction of the hole axis arranged along a direction perpendicular to the respective flat surfaces of the first wall 21, the flat board portion Hai, and the second wall (FIG. 1). The through-hole 32 is circularly formed to receive a male screw member (not illustrated). The terminal unit 31 of this embodiment is an area (a terminal area of, what-is-called, an LA terminal) to be fastened by male and female screw members.

An inner peripheral wall surface of the through-hole 32 consists of a first outer layer exposure surface 32a as a part of the first wall 21, a middle layer exposure surface 32b as a part of the flat board portion Hai, and a second outer layer exposure surface 32c as a part of the second wall 22 (FIG. 1).

The terminal-formed electrical wire 1 described above is made by the following method of manufacturing.

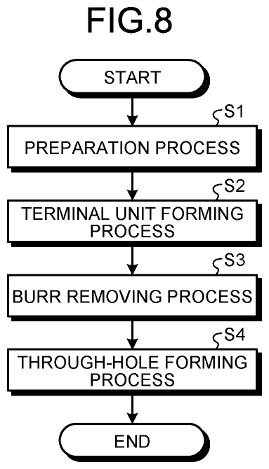

This method of manufacturing includes a preparation process at which the core wire exposed portion 11a of the electrical wire 10 is inserted into the tubular member 20 (FIG. 4 and FIG. 8). At the preparation process, a leading end of the core wire exposed portion 11a is inserted through an opening located at an end of the tubular member 20 and is moved to reach the other opening 20a of the tubular member 20. At this preparation process, an end of the sheath 12 closer to the core wire exposed portion 11a is also inserted into the tubular member 20.

This method of manufacturing further includes a terminal unit forming process. At this process, the terminal target portion 20b and the core wire exposed portion 11a inside the terminal target portion 20b are formed into the terminal unit 31 having a desired terminal shape, by sandwiching the terminal target portion 20b of the tubular member 20 between a pair of press tools 111 and 112 and pressing the terminal target portion 20b with the pair of press tools 111 and 112 (FIGS. 5, 6, and 8).

At the terminal unit forming process of this embodiment, the terminal target portion 20b is pressed by the pair of press tools 111 and 112 while heated, which is to weld and solidify a plurality of wires 13 composing the core wire exposed portion 11a inside the terminal target portion 20b. This process allows the terminal target portion 20b and the wires 13 inside the terminal target portion 20b to be formed into the terminal unit 31. At the terminal unit forming process, when the wires 13 are welded, outer wires 13, of the wires 13 being melting, stick to the inner peripheral surface of the tubular member 20. For example, at the terminal unit forming process, the tubular member 20 may be pressed by the pair of press tools 111 and 112 while heat of a heating device (not illustrated), such as a heater, is directly transferred to the tubular member 20 or while the heat of the heating device is indirectly transferred through the pair of press tools 111 and 112. At the terminal unit forming process, heat may be applied to the terminal target portion 20b by passing current to a pair of electrodes, as the pair of press tools 111 and 112, while the pair of electrodes is pressing the terminal target portion 20b. In other words, at the terminal unit forming process, the wires 13 may be subjected to resistance welding.

At the terminal unit forming process, the terminal target portion 20b and the core wire exposed portion 11a inside the terminal target portion 20b are flattened by simultaneously being pressed and heated. This process makes the terminal target portion 20b into a tubular, for example, rectangular tubular, compressed tube portion 20c and makes the core wire exposed portion 11a into the flat board portion 11a₁ in the shape of a flat board inside the compressed tube portion 20c. In this manner, this terminal unit forming process forms the terminal unit 31 from the compressed tube portion 20c and the flat board portion Hai.

This method of manufacturing includes a through-hole forming process at which the through-hole 32 is formed in the terminal unit 31 (FIG. 1 and FIG. 8). This through-hole forming process forms the through-hole 32 formed in a circular shape and having the direction of the hole axis arranged along a direction perpendicular to the flat surfaces of the first wall 21 of the compressed tube portion 20c, the flat board portion Hai, and the second wall 22 of the compressed tube portion 20c.

In this method of manufacturing, when the wires 13 are solidified at the terminal unit forming process, burrs of the wires 13 may sometimes stick out of the other opening 20a of the tubular member 20 (the compressed tube portion 20c). This method of manufacturing therefore includes a burr removing process to remove the burrs after the terminal unit forming process (FIG. 8). This burr removing process may be performed before the through-hole forming process or may be performed together with the through-hole forming process. For example, this method of manufacturing uses press cutting to remove burrs, which allows the burr removing process and the through-hole forming process to be performed at the same time.

In this method of manufacturing, the core wire exposed portion 11a is accommodated in the tubular member 20 having openings at the respective ends. In this structure, when the core wire exposed portion 11a is flattened, the position from which a burr sticks out is restricted to an area of the tubular member 20 (the compressed tube portion 20c) closer to the other opening 20a. In other words, this method of manufacturing allows the position from which a burr sticks out to be managed in a predetermined area. This method of manufacturing is therefore advantageous in improving workability of removing burrs.

The tubular member 20 has the other opening 20a covered by a lid (not illustrated) and accommodates the core wire exposed portion 11a such that the leading end of the core wire exposed portion 11a is located at a position spaced from the lid. This structure can keep burrs from sticking out when the wires 13 are solidified. As a preferable requirement for the above-described tubular member 20, when the lid is flattened at the terminal unit forming process, the lid would not be a problematic component, for example, by being deformed into a sharp projection.

As described above, in the method of manufacturing the terminal-formed electrical wire, since the pair of press tools 111 and 112 apply load to the core wire exposed portion 11a through the tubular member 20 at the terminal unit forming process, the core wire exposed portion 11a is exposed to neither the outer surface of the first wall 21 nor the outer surface of the second wall 22 of the terminal unit 31. The method of manufacturing a terminal-formed electrical wire and the terminal-formed electrical wire 1 formed by using this method of manufacturing can maintain the consistency in the shape of the terminal unit 31 across a plurality of terminal-formed electrical wires 1, in comparison with a conventional terminal unit having the core wire exposed portion directly pressed. This method of manufacturing a terminal-formed electrical wire therefore allows for manufacturing of the terminal-formed electrical wire 1 provided with a high-quality terminal unit 31. The terminal-formed electrical wire 1 formed by this method of manufacturing is therefore allowed to be provided with a high-quality terminal unit 31.

In the method of manufacturing a terminal-formed electrical wire and the terminal-formed electrical wire 1 formed by using this method of manufacturing, the core wire exposed portion 11a is exposed to neither the outer surface of the first wall 21 nor the outer surface of the second wall 22 of the terminal unit 31. Irregularity of the outer surfaces is therefore small, in comparison with a conventional terminal unit having the core wire exposed portion directly pressed. In other words, the method of manufacturing a terminal-formed electrical wire allows for formation of a smooth terminal unit 31 in which roughness of the outer surfaces of the first wall 21 and the second wall 22 caused by the wires 13 is reduced. Therefore, in the terminal-formed electrical wire 1 formed by using this method of manufacturing, when the terminal unit 31 is fastened by a screw member, the seating surface of the screw member buckles the outer surface of the first wall 21 or the second wall 22 by a comparatively reduced amount, with respect to a conventional terminal unit having the core wire exposed portion directly pressed. This method therefore eliminates the necessity of further tightening or retightening the screw member from the terminal-formed electrical wire 1, which facilitates management of the torque for screw tightening and facilitates generation of the axial force of the screw member. In this respect, the terminal-formed electrical wire 1 is provided with the high-quality terminal unit 31. The method of manufacturing a terminal-formed electrical wire accordingly allows for manufacturing of the terminal-formed electrical wire 1 provided with the high-quality terminal unit 31.

In the method of manufacturing a terminal-formed electrical wire, heat is applied to the core wire exposed portion 11a through the tubular member 20 at the terminal unit forming process. This manner can evenly transfer heat to each of the wires 13 of the core wire exposed portion 11a and thus can evenly weld the wires 13 of the core wire exposed portion 11a. Therefore, when the pair of press tools 111 and 112 apply load to the core wire exposed portion 11a through the tubular member 20 at the terminal unit forming process, the wires 13 of the core wire exposed portion 11a can be easily evenly flattened. In other words, the method of manufacturing a terminal-formed electrical wire can improve processability of the terminal unit 31. This method allows for easy production of the terminal unit 31 having a consistent shape across a plurality of terminal-formed electrical wires 1 and having smooth outer surfaces of the first wall 21 and the second wall 22. In this respect, the method of manufacturing a terminal-formed electrical wire allows for manufacturing of the terminal-formed electrical wire 1 provided with the high-quality terminal unit 31. The terminal-formed electrical wire 1 formed by using this method of manufacturing is therefore allowed to be provided with the high-quality terminal unit 31.

Since this terminal-formed electrical wire 1 has the core wire exposed portion 11a covered by the tubular member 20, the tubular member 20 is allowed to function as a reinforcing member of the terminal unit 31. In particular, in this terminal-formed electrical wire 1, the function as a reinforcing member can be enhanced by forming the tubular member 20 using a metallic material stronger than the wire 13. For example, the tubular member 20 of this embodiment is formed of copper or copper alloy. As described above, in the terminal-formed electrical wire 1, the tubular member 20 having a function as a reinforcing member makes the terminal unit 31 stronger against breakage and buckling. In this respect, the terminal unit 31 in high quality can be provided. The method of manufacturing a terminal-formed electrical wire therefore allows for manufacturing of the terminal-formed electrical wire 1 provided with the high-quality terminal unit 31.

In the method of manufacturing a terminal-formed electrical wire according to the present embodiment, the pair of press tools apply load to the core wire exposed portion through the tubular member at the terminal unit forming process, which keeps the core wire exposed portion from being exposed to the outer surfaces of the first wall and the second wall of the terminal unit. The method of manufacturing a terminal-formed electrical wire and the terminal-formed electrical wire formed by using this method of manufacturing can maintain the consistency in the shape of the terminal unit across a plurality of terminal-formed electrical wires, in comparison with a conventional terminal unit having the core wire exposed portion directly pressed. This method of manufacturing a terminal-formed electrical wire therefore allows for manufacturing of a terminal-formed electrical wire provided with a high-quality terminal unit. The terminal-formed electrical wire according to the present embodiment is therefore allowed to be provided with a high-quality terminal unit.

In the method of manufacturing a terminal-formed electrical wire and the terminal-formed electrical wire formed by using this method of manufacturing, the core wire exposed portion is exposed to neither the outer surface of the first wall nor the outer surface of the second wall of the terminal unit. Irregularity of the outer surfaces is therefore small, in comparison with a conventional terminal unit having the core wire exposed portion directly pressed. In other words, the method of manufacturing a terminal-formed electrical wire allows for formation of a smooth terminal unit in which roughness of the outer surfaces of the first wall and the second wall caused by the wires is reduced. In the terminal-formed electrical wire formed by using this method of manufacturing, when the terminal unit is fastened by a screw member, a seating surface of the screw member buckles the outer surface of the first wall or the second wall by a comparatively reduced amount, with respect to a conventional terminal unit having the core wire exposed portion directly pressed. This method therefore eliminates the necessity of further tightening or retightening the screw member, from the terminal-formed electrical wire, which facilitates management of the torque for screw tightening and facilitates generation of the axial force of the screw member. In this respect, the terminal-formed electrical wire is provided with a high-quality terminal unit. This method of manufacturing a terminal-formed electrical wire therefore allows for manufacturing of the terminal-formed electrical wire with a high-quality terminal unit.

In this method of manufacturing a terminal-formed electrical wire, heat is applied to the core wire exposed portion through the tubular member at the terminal unit forming process. This manner can evenly transfer heat to each of the wires of the core wire exposed portion and thus can evenly weld the wires of the core wire exposed portion. Therefore, when the pair of press tools apply load to the core wire exposed portion through the tubular member at the terminal unit forming process, the wires of the core wire exposed portion can be easily evenly flattened. In other words, this method of manufacturing a terminal-formed electrical wire can improve processability of the terminal unit and thus allows for easy production of the terminal unit having a consistent shape across a plurality of terminal-formed electrical wires and having smooth outer surfaces on the first wall and the second wall. In this respect, this method of manufacturing a terminal-formed electrical wire allows for manufacturing of the terminal-formed electrical wire provided with a high-quality terminal unit. The terminal-formed electrical wire formed by using this method of manufacturing is therefore allowed to be provided with a high-quality terminal unit.

Since this terminal-formed electrical wire has the core wire exposed portion covered by the tubular member, the tubular member is allowed to function as a reinforcing member of the terminal unit. This structure of the terminal-formed electrical wire can make the terminal unit stronger against breakage and buckling. In this respect, the terminal unit of excellent quality is provided. This method of manufacturing a terminal-formed electrical wire therefore allows for manufacturing of the terminal-formed electrical wire provided with a high-quality terminal unit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal-formed electrical wire, comprising:
a core wire;
a sheath that exteriorly covers a sheath target portion, as a portion other than a core wire exposed portion, of the core wire; and
a metallic tubular member that accommodates the core wire exposed portion inside and is integrated with the core wire exposed portion to form a terminal unit, wherein
the core wire exposed portion has a flat board portion formed in a shape of flat board that is thinner than the sheath target portion,
the tubular member has a first wall and a second wall each formed in a shape of flat board and sandwiching the flat board portion from respective flat surfaces of the flat board portion, and
the terminal unit has a through-hole having a direction of a hole axis arranged along a direction perpendicular to respective flat surfaces of the first wall, the flat board portion, and the second wall.

2. The terminal-formed electrical wire according to claim 1, wherein
the tubular member further accommodates a portion of the sheath connected with the core wire exposed portion.

3. The terminal-formed electrical wire according to claim 1, wherein
the core wire is a bundle of a plurality of wires.

4. The terminal-formed electrical wire according to claim 2, wherein
the core wire is a bundle of a plurality of wires.

5. A method of manufacturing a terminal-formed electrical wire, the method comprising:
preparing by inserting a core wire exposed portion of a core wire of an electrical wire into a metallic tubular member;
forming a terminal unit by making a terminal target portion of the tubular member and the core wire exposed portion inside the terminal target portion into a terminal unit having a desired terminal shape, by pressing the terminal target portion with a pair of press tools; and
forming a through-hole in the terminal unit.

6. The method of manufacturing a terminal-formed electrical wire according to claim 5, wherein,
at the forming the terminal unit, the terminal target portion and a plurality of wires arranged inside the terminal target portion are formed into the terminal unit, by pressing the terminal target portion with the pair of press tools while heating the terminal target portion to weld and solidify the wires inside the terminal target portion and composing the core exposed portion.

7. The method of manufacturing a terminal-formed electrical wire according to claim 6, wherein,
at the forming the terminal unit, heat is applied to the terminal target portion by passing current to a pair of electrodes, as the pair of press tools, while the pair of electrodes is pressing the terminal target portion.
